(19) United States
(12) Patent Application Publication
(10) Pub. No.: US 2012/0058214 A1
(43) Pub. Date: Mar. 8, 2012

(54) MULTIPLE PRESS MOLDING MACHINE

(75) Inventor: Eiji KITAI, Toyota-shi (JP)

(73) Assignee: KOJIMA PRESS INDUSTRY CO., LTD., Toyota-shi (JP)

(21) Appl. No.: 12/979,900

(22) Filed: Dec. 28, 2010

(30) Foreign Application Priority Data
Sep. 3, 2010 (JP) 2010-197568

(51) Int. Cl. B29C 43/00

(52) U.S. Cl. 425/186

(57) ABSTRACT

A multiple press molding machine may include a plurality of guide shafts and a plurality of die units. Each of the die units includes a pair of dies, a plurality of guide holes and a plurality of bushes each having a through bore. Each of the bushes is positioned so as to surround at least one open peripheries of each of the guide holes. The guide shafts are respectively inserted into the guide holes of the die units and the through bores of the bushes, so that die closing and opening motion can be guided. The through bore of each of the bushes has an inner diameter smaller than a diameter of each of the guide holes.

This application claims the benefit of priority to Japanese application no. 2010-197568 filed Sep. 3, 2010, the content of which is hereby incorporated by reference in its entirety and for all purposes.

### STATEMENT REGARDING FEDERALLY SPONSORED RESEARCH OR DEVELOPMENT

Not applicable.

### BACKGROUND OF THE INVENTION

1. Field of Invention

The invention generally relates to a multiple press molding machine. More particularly, embodiments of the invention relate to a multiple press molding machine in which a plurality of die units each having a pair of dies are disposed in series in a die closing and opening direction.

2. Background of Technology

A known multiple press molding machine is taught by, for example, Japanese Laid-Open Patent Publication Number 2002-178194. The multiple press molding machine includes a plurality of die units (three die units) each having a pair of dies (upper and lower dies) are disposed in series in a die closing and opening direction (a vertical direction). Such a multiple press molding machine can be operated using a low-volume hydraulic press cylinder compared with a press molding machine in which a plurality of die units (three die units) each having a pair of dies are separately disposed in parallel. That is, in the multiple press molding machine, a force (a cylinder volume) that is required to operate each of the die units can be reduced. In addition, the multiple press molding machine can be placed in a limited space.

The known multiple press molding machine includes upper and lower frames, and guide shafts that are vertically positioned between the upper and lower frames and connected thereto. The pair of dies of the die units are respectively attached to die plates. The die plates are connected to the guide shafts so as to be capable of vertically moving therealong. Thus, in the multiple press molding machine, the guide shafts are used as support columns that connect the upper and lower frames. Therefore, if a large load is applied to the upper frame, the guide shafts can be flexed. As a result, the die plates cannot smoothly moving along the guide shafts.

Thus, there is a need in the art for an improved multiple press molding machine.

### BRIEF SUMMARY OF THE INVENTION

For example, in one embodiment of the invention, a multiple press molding machine may include a plurality of guide shafts and a plurality of die units. Each of the die units includes a pair of dies, a plurality of guide holes and a plurality of bushes each having a through bore. Each of the bushes is positioned so as to surround at least one open peripheries of each of the guide holes. The guide shafts are respectively inserted into the guide holes of the die units and the through bores of the bushes, so that die closing and opening motion can be guided. The through bore of each of the bushes has an inner diameter smaller than a diameter of each of the guide holes.

Thus, according to a triple press molding machine thus constructed, even when the guide shafts are flexed due to a large load applied thereto, the guide holes can absorb produced flexural deformation of the guide shafts. Therefore, the guide holes can be reliably guided by the guide shafts, so that the die units can be smoothly closed and opened. In addition, the bushes can increase guiding accuracy of the guide shafts to the guide holes. Thus, the guide holes can be more reliably guided by the guide shafts, so that the die units can be further smoothly closed and opened. As a result, the die units can be effectively prevented from being inclined or rattled.

In one embodiment of the invention, each of the die units includes movable die plates. The guide holes are formed in the movable die plates so as to penetrate the movable die plates in a thickness direction thereof. Each pair of dies are detachably connected to the movable die plates, so as to move in a die closing and opening direction and a direction perpendicular thereto.

Other objects, features and advantage of the inventions will be readily understood after reading the following detailed description together with the accompanying drawings and the claims.

### BRIEF DESCRIPTION OF THE DRAWINGS

FIG. 1 is an elevational view of a triple press molding machine according to a representative embodiment of the invention, which view illustrates an open condition thereof.

FIG. 2 is a vertical sectional view of a portion in which a guide shaft is inserted into a guide hole formed in a drive die plate (a top die plate);

FIG. 3 is a partially enlarged elevational view of a top upper die (a first upper die) of a top die unit, which view illustrates a condition in which it is not attached to the drive die plate;

FIG. 4 is a bottom view of FIG. 3;

FIG. 5 is a partially enlarged elevational view of the top upper die of the top die unit, which view illustrates a condition in which it is attached to the drive die plate;

FIG. 6 is a bottom view of FIG. 5; and

FIG. 7 is an elevational view of the triple press molding machine, which view illustrates a closed condition thereof.

### DETAILED DESCRIPTION OF THE INVENTION

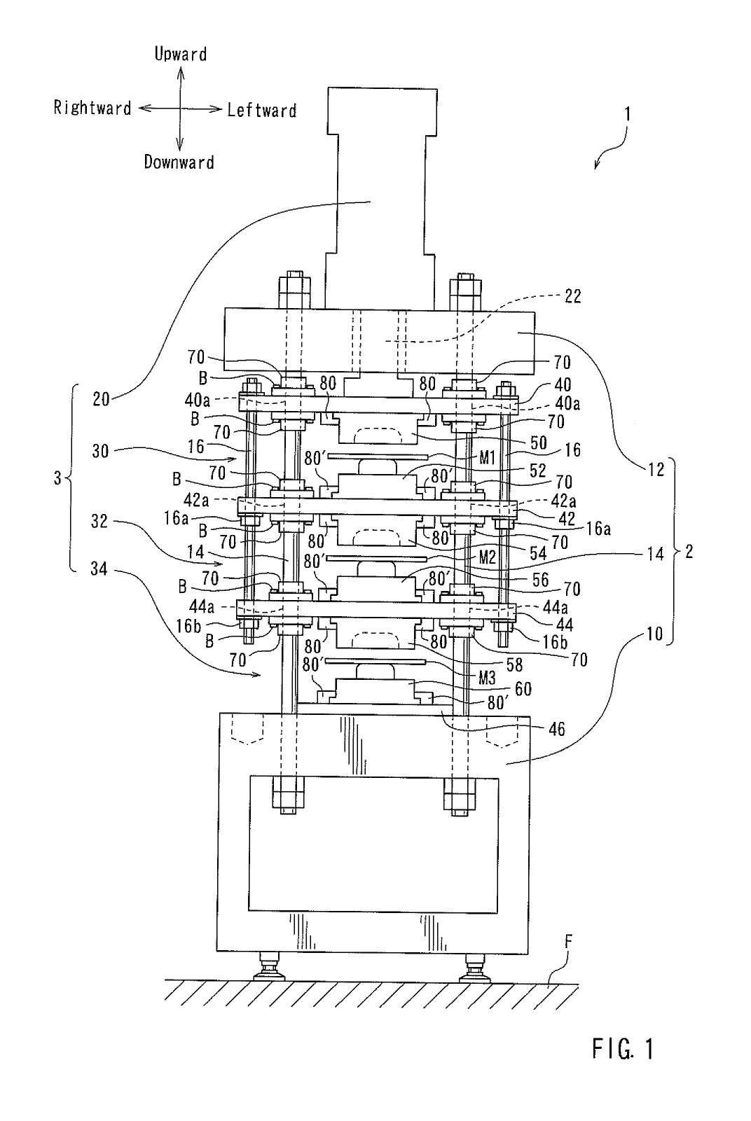

A detailed embodiment of the invention is shown in FIG. 1 to FIG. 7.

Further, in the following description, a vertical triple press molding machine 1 is exemplified as a multiple press molding machine. Further, forward and rearward, rightward and leftward, and upward and downward in the drawings respectively correspond to forward and rearward, rightward and leftward, and upward and downward of the triple press molding machine 1.

As shown in FIG. 1, the triple press molding machine 1 is essentially constructed of a frame portion 2, and a press portion 3 that is capable of press forming materials M1, M2 and M3. The frame portion 2 is composed of a lower frame 10 disposed on a floor F, an upper frame 12 positioned above the lower frame 10, and four guide shafts 14. The upper frame 12 is positioned in parallel with the lower frame 10 such that a lower surface of the upper frame 12 faces an upper surface of the lower frame 10. The guide shafts 14 are vertically positioned between the upper frame 12 and the lower frame 10 and are connected thereto at four corners thereof.

The press portion 3 is constructed of a press cylinder 20 as a drive source, and three die units 30, 32 and 34 (which will respectively be hereinafter referred to as a first die unit 30, a second die unit 32 and a third die unit 34). The first to third die units 30, 32 and 34 are respectively constructed to press form the materials M1, M2 and M3 when the triple press molding machine 1 is closed due to actuation of the press cylinder 20.

The press cylinder 20 is disposed on and connected to an upper surface of the upper frame 12 while a cylinder rod 22 thereof vertically penetrates the upper frame 12. The press cylinder 20 is constructed such that the cylinder rod 22 can be projected and contracted due to a hydraulic pressure externally applied thereto.

Next, the first die unit 30 will be described. The first die unit 30 is constructed of a drive die plate 40 (a movable die plate), a first driven die plate 42 (a movable die plate) paired with the drive die plate 40, a first upper die 50, and a first lower die 52 paired with the first upper die 50. The drive die plate 40 may function as a base plate to which the first upper die 50 is attached. The drive die plate 40 has four guide holes 40a that are formed in four corners thereof. The guide holes 40a are formed to penetrate the drive die plate 40 in a thickness direction thereof and are shaped such that the four guide shafts 14 can be inserted thereinto.

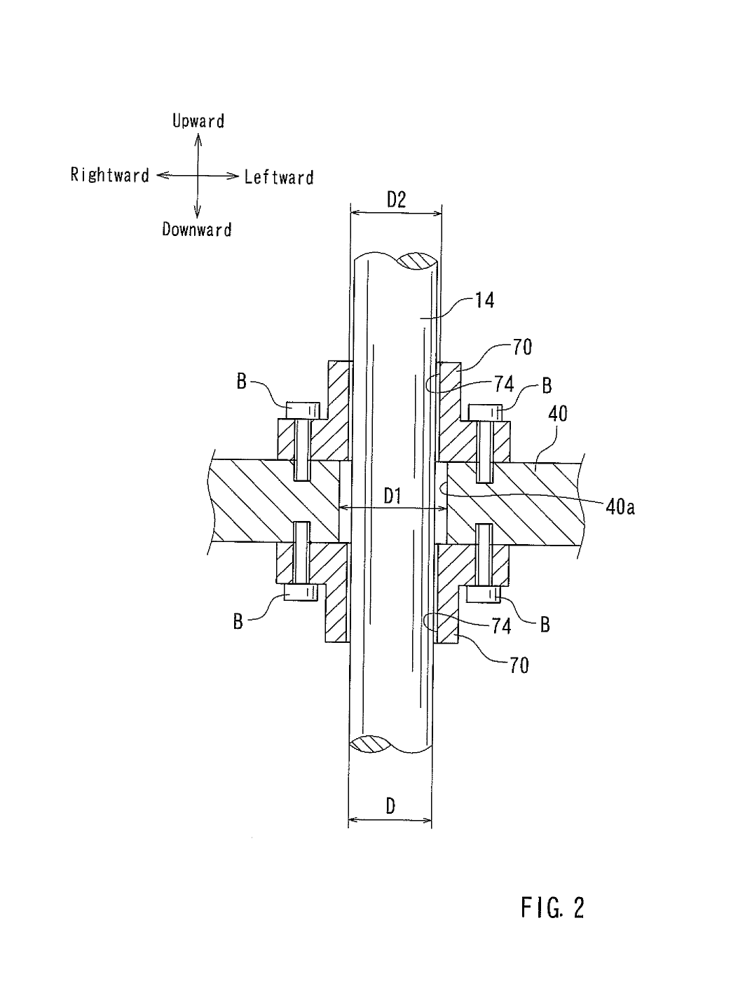

As shown in FIG. 2, each of the guide holes 40a has a (inner) diameter D1 sufficiently greater than a (outer) diameter D of each of the guide shafts 14 (D1>D). Thus, when the guide shafts 14 are flexed due to a large load applied to the lower frame 10 via the upper frame 12, the guide holes 40a can absorb produced flexural deformation of the guide shafts 14. Therefore, the guide holes 40a can be reliably guided by the guide shafts 14 (i.e., the guide shafts 14 can freely slide or move within the guide holes 40a) even when the guide shafts 14 are flexed, so that the drive die plate 40 can smoothly move up and down.

As shown in FIG. 1, four (upper and lower) pairs of bushes 70 (two pairs of bushes 70 are shown) are attached to upper and lower surfaces of the drive die plate 40 via connector bolts B. As shown in FIG. 2, the bushes 70 respectively have through bores 74 into which the guide shafts 14 can respectively be inserted. Further, the bushes 70 are positioned such that the through bores 74 can respectively be aligned with the guide holes 40a. That is, the bushes 70 are attached to the drive die plate 40 so as to surround upper and lower open peripheries of the guide holes 40a. As will be recognized, the bushes 70 are provided in order to increase guiding accuracy of (i.e., in order to reliably guide) the guide shafts 14 to the guide holes 40a of the drive die plate 40. Therefore, as shown in FIG. 2, each of the through bores 74 has a (inner) diameter D2 smaller than the diameter D1 of each of the guide holes 40a (D2<D1).

According to the bushes 70 thus positioned, the guide holes 40a can be reliably guided by the guide shafts 14, so that the drive die plate 40 can smoothly move up and down. As a result, the drive die plate 40 can be effectively prevented from being inclined or rattled. In addition, binding or galling between the guide shafts 14 and the guide holes 40a can be prevented. Further, the bushes 70 may preferably be made of cast iron.

As shown in FIG. 1, the drive die plate 40 thus formed is connected to a distal (lower) end of the cylinder rod 22 of the press cylinder 20 while the guide shafts 14 are respectively inserted into the guide holes 40a formed in the drive die plate 40 and the through bores 74 of the bushes 70. Thus, when the cylinder rod 22 is projected and contracted, the drive die plate 40 can move up and down while the guide holes 40a are respectively guided by the guide shafts 14. At this time, the drive die plate 40 can smoothly move up and down with the aid of the through bores 74 of the bushes 70, so that the drive die plate 40 can be reliably prevented from being inclined or rattled. Further, the drive die plate 40 may preferably be made of iron.

The first driven die plate 42 may function as a base plate to which the first lower die 52 is attached. Similar to the drive die plate 40, the first driven die plate 42 has four guide holes 42a that are formed in four corners thereof. The guide holes 42a are shaped such that the four guide shafts 14 can be inserted thereinto.

Similar to the guide holes 40a, each of the guide holes 42a has a (inner) diameter sufficiently greater than the diameter D of each of the guide shafts 14. Preferably, each of the guide holes 42a has the same diameter as the diameter D1 of each of the guide holes 40a. Thus, similar to the drive die plate 40 described above, when the guide shafts 14 are flexed caused by the large load applied to the lower frame 10 via the upper frame 12, the guide holes 42a can absorb the produced flexural deformation of the guide shafts 14. Therefore, the guide holes 42a can be reliably guided by the guide shafts 14 (i.e., the guide shafts 14 can freely slide or move within the guide holes 42a) even when the guide shafts 14 are flexed, so that the first driven die plate 42 can smoothly move up and down.

Similar to the drive die plate 40, four pairs of bushes 70 (two pairs of bushes 70 are shown) are attached to upper and lower surfaces of the first driven die plate 42 via the connector bolts B. The bushes 70 respectively have through bores 74 into which the guide shafts 14 can respectively be inserted. Further, the bushes 70 are positioned such that the through bores 74 thereof can respectively be aligned with the guide holes 42a. That is, the bushes 70 are attached to the first driven die plate 42 so as to surround upper and lower open peripheries of the guide holes 42a. The bushes 70 can increase guiding accuracy of the guide shafts 14 to the guide holes 42a of the first driven die plate 42. Each of the through bores 74 has a (inner) diameter smaller than the diameter of each of the guide holes 42a.

According to the bushes 70 thus positioned, the guide holes 42a can be reliably guided by the guide shafts 14, so that the first driven die plate 42 can smoothly move up and down. As a result, the first driven die plate 42 can be effectively prevented from being inclined or rattled. In addition, binding or galling between the guide shafts 14 and the guide holes 42a can be prevented. Further, the bushes 70′ may preferably be made of cast iron.

As shown in FIG. 1, the first driven die plate 42 thus formed is connected to the drive die plate 40 via four connector shafts 16 suspended from the drive die plate 40 while the guide shafts 14 are respectively inserted into the guide holes 42a formed in the first driven die plate 42 and the through bores 74 of the bushes 70. Thus, when the cylinder rod 22 is projected and contracted, the first driven die plate 42 can move up and down while the guide holes 42a are respectively guided by the guide shafts 14. At this time, the first driven die plate 42 can smoothly move up and down with the drive die plate 40 with the aid of the through bores 74 of the bushes 70, so that the first driven die plate 42 can be reliably prevented from being inclined or rattled. Further, the first driven die plate 42 may preferably be made of iron.

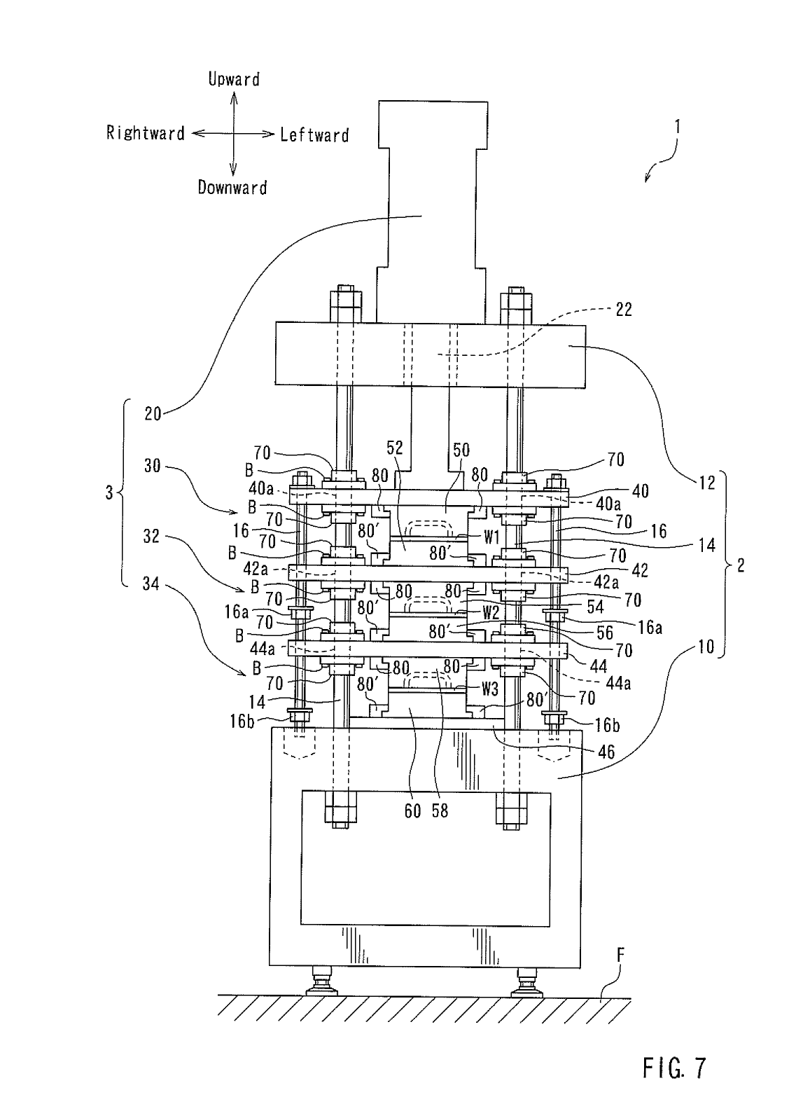

Further, as shown in FIGS. 1 and 7, four stopper members 16a are respectively attached to the connector shafts 16 such that the first driven die plate 42 can be prevented from being excessively lowered when the first upper and lower dies 50 and 52 are opened (i.e., such that the first upper and lower dies 50 and 52 can be prevented from being excessively opened). Thus, lowering motion of the first driven die plate 42 (the first lower die 52) can be limited by the stopper members 16a. Further, each of the stopper members 16a is adjustably attached to the connector shaft 16, so as to change a farthest lower position (a lowermost position) of the first driven die plate 42 (the first lower die 52).

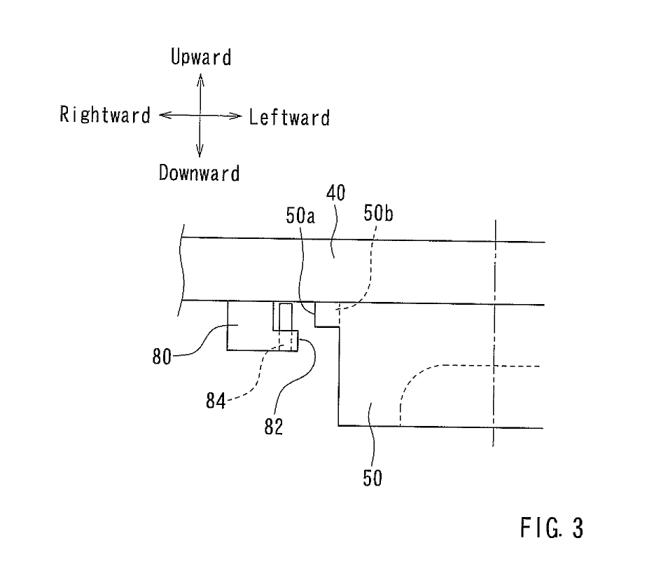

The first upper die 50 is constructed to mate with the first lower die 52, thereby press forming the material M1. As shown in, for example, FIG. 1, the first upper die 50 is detachably connected to the lower surface of the drive die plate 40 via a right and left pair of first upper die attaching structures respectively having support blocks 80. Further, the first upper die attaching structures are symmetrical to each other and have the same structures as each other. Therefore, only the left first upper die attaching structure will be described with reference to FIGS. 3 to 6.

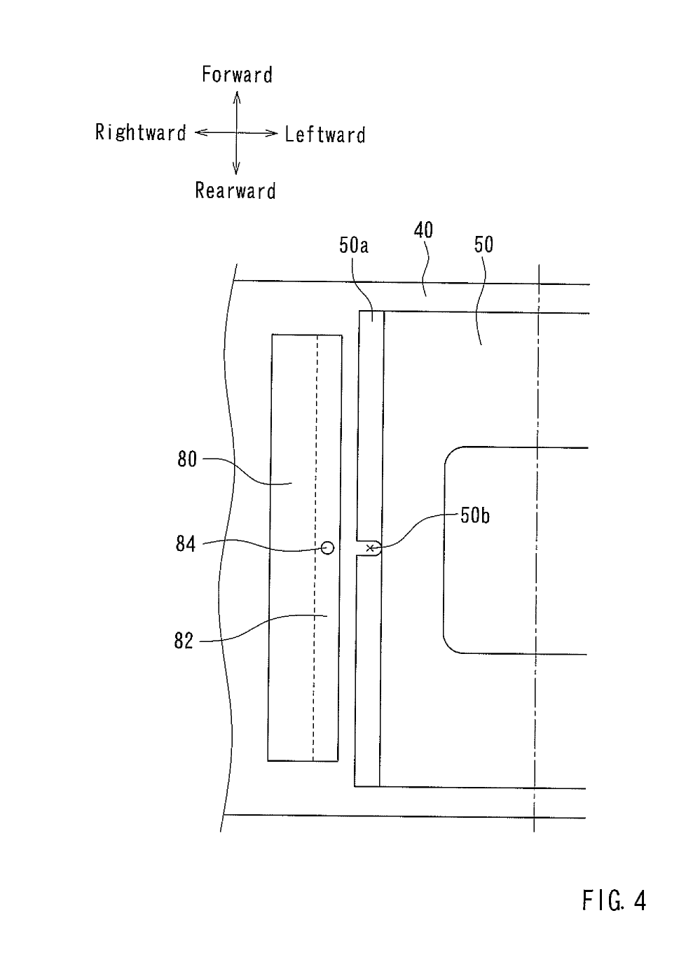

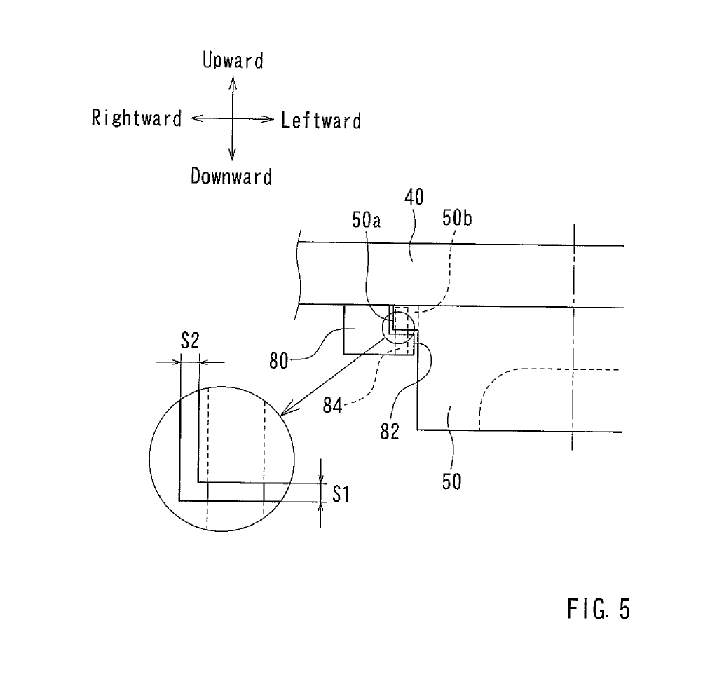

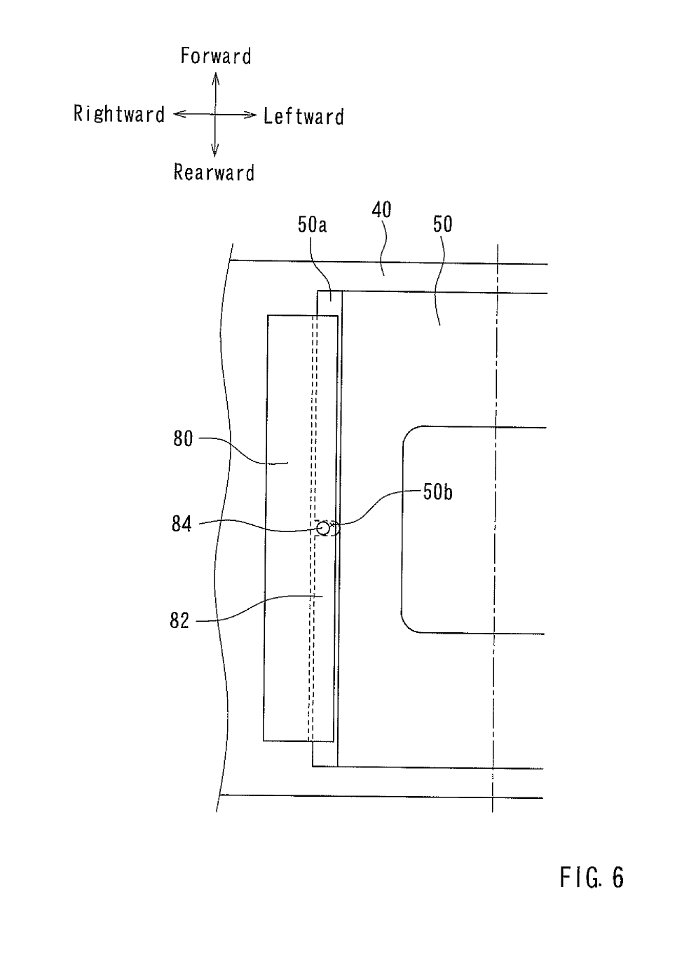

As shown in FIGS. 4 and 6, the support block 80 is a block-shaped member that is elongated in forward and rearward. Further, as shown in FIGS. 3 and 5, the support block 80 has an L-shape in cross section and has a shouldered portion 82 that is extended rightwardly (inwardly). An upper surface of the support block 80 is slidably attached to the lower surface of the drive die plate 40 via a known slide mechanism (not shown), so as to be slidable laterally (right and left). Further, as shown in FIGS. 3 and 5, the support block 80 includes a stud pin 84 that is formed in the shouldered portion 82 so as to project toward the lower surface of the drive die plate 40. As shown in FIGS. 4 and 6, the stud pin 84 is positioned on a longitudinally central portion of the shouldered portion 82.

Conversely, as shown in FIGS. 3 and 5, the first upper die 50 has an elongated flanged portion 50a that is formed in a left upper end periphery thereof. As shown in FIGS. 4 and 6, the flanged portion 50a extends in an entire length of the left upper end periphery of the first upper die 50. The flanged portion 50a has a U-shaped notch 50b that is shaped to closely engage the stud pin 84 of the support block 80. Further, as shown in FIGS. 4 and 6, the notch 50b is formed in a longitudinally central portion of the shouldered portion 82.

Further, as shown in an encircled enlarged view in FIG. 5, a thickness (height) of the flanged portion 50a is determined such that a clearance S1 can be formed between a lower surface of the flanged portion 50a and an upper surface of the shouldered portion 82 of the support block 80 when the support block 80 engages the flanged portion 50a of the first upper die 50 while the first upper die 50 contacts the lower surface of the drive die plate 40, which will be hereinafter described.

In order to attach the first upper die 50 to the drive die plate 40, as shown in FIGS. 3 and 4, the first upper die 50 is disposed on a desired position on the lower surface of the drive die plate 40. Thereafter, as shown in FIGS. 4 and 6, the support block 80 is slid rightwardly until the stud pin 84 formed in the shouldered portion 82 of the support block 80 engages the notch 50b formed in the flanged portion 50a of the first upper die 50. At this time, as shown in the encircled enlarged view in FIG. 5, the support block 80 is slid rightwardly such that a clearance S2 can be formed or left between a side surface of the flanged portion 50a and a (right) side surface of the support block 80.

Upon engagement of the stud pin 84 and the notch 50b, the first upper die 50 can be securely coupled to the support block 80 because the notch 50b is capable of closely engaging the stud pin 84. As a result, the first upper die 50 can be detachably securely connected to the lower surface of the drive die plate 40 via the support block 80 that is attached to the drive die plate 40.

Thus, the first upper die 50 is connected to the drive die plate 40 via the support block 80 while the clearances S1 and S2 are formed between the flanged portion 50a of the first upper die 50 and the support block 80. Therefore, if a large force is applied to the first upper die 50 during a closing operation or an opening operation of the first die unit 30, the first upper die 50 can displace or move vertically and laterally (in a die closing and opening direction and a direction perpendicular thereto) relative to the drive die plate 40.

As will be appreciated, in order to remove the first upper die 50 from the drive die plate 40, the support block 80 is simply slid in reverse direction (leftwardly).

The first lower die 52 is constructed to mate with the first upper die 50, thereby press forming the material M1. The first lower die 52 is detachably connected to the upper surface of the first driven die plate 42 via a right and left pair of first lower die attaching structures respectively having support blocks 80′. Further, the first lower die attaching structures (the support blocks 80′) are respectively symmetrical with the first upper die attaching structures (the support blocks 80) and respectively have the same structures as the first upper die attaching structures. Therefore, a detailed description of the first lower die attaching structures may be omitted.

Next, the second die unit 32 will be described. The second die unit 32 is constructed of the first driven die plate 42, a second driven die plate 44 (a movable die plate) paired with the first driven die plate 42, a second upper die 54, and a second lower die 56 paired with the second upper die 54.

Further, the first driven die plate 42 is a construction element common to the first and second die units 30 and 32 and is already described in detail. Therefore, a detailed description of the first driven die plate 42 may be omitted.

The second driven die plate 44 may function as a base plate to which the second lower die 56 is attached. Similar to the drive die plate 40 and the first driven die plate 42, the second driven die plate 44 has four guide holes 44a that are formed in four corners thereof. The guide holes 44a are shaped such that the four guide shafts 14 can be inserted thereinto.

Similar to the guide holes 40a and the guide holes 42a, each of the guide holes 44a has a (inner) diameter sufficiently greater than the diameter D of each of the guide shafts 14. Preferably, each of the guide holes 44a has the same diameter as the diameter D1 of each of the guide holes 40a. Thus, similar to the drive die plate 40 and the first driven die plate 42 described above, when the guide shafts 14 are flexed caused by the large load applied to the lower frame 10 via the upper frame 12, the guide holes 44a can absorb the produced flexural deformation of the guide shafts 14. Therefore, the guide holes 44a can be reliably guided by the guide shafts 14 (i.e., the guide shafts 14 can freely slide or move within the guide holes 44a) even when the guide shafts 14 are flexed, so that the second driven die plate 44 can smoothly move up and down.

Similar to the drive die plate 40 and the first driven die plate 42, the four pairs of bushes 70 are attached to upper and lower surfaces of the second driven die plate 44 via the connector bolts B. The bushes 70 respectively have through bores 74 into which the guide shafts 14 can respectively be inserted. Further, the bushes 70 are positioned such that the through bores 74 thereof can respectively be aligned with the guide holes 44a. That is, the bushes 70 are attached to the second driven die plate 44 so as to surround upper and lower open peripheries of the guide holes 44a. The bushes 70 can increase guiding accuracy of the guide shafts 14 to the guide holes 44a of the second driven die plate 44. Each of the through bores 74 has a (inner) diameter smaller than the diameter of each of the guide holes 44a.

According to the bushes 70 thus positioned, the guide holes 44a can be reliably guided by the guide shafts 14, so that the second driven die plate 44 can smoothly move up and down. As a result, the second driven die plate 44 can be effectively prevented from being inclined or rattled. In addition, binding or galling between the guide shafts 14 and the guide holes 44a can be prevented. Further, the bushes 70 may preferably be made of cast iron.

As shown in FIG. 1, similar to the first driven die plate 42, the second driven die plate 44 thus formed is connected to the drive die plate 40 via the four connector shafts 16 suspended from the drive die plate 40 while the guide shafts 14 are respectively inserted into the guide holes 44a formed in the second driven die plate 44 and the through bores 74 of the bushes 70. Thus, when the cylinder rod 22 is projected and contracted, the second driven die plate 44 can move up and down while the guide holes 44a are respectively guided by the guide shafts 14. At this time, the second driven die plate 44 can smoothly move up and down with the drive die plate 40 with the aid of the through bores 74 of the bushes 70, so that the second driven die plate 44 can be reliably prevented from being inclined or rattled. Further, the second driven die plate 44 may preferably be made of iron.

Further, as shown in FIGS. 1 and 7, four stopper members 16b are respectively attached to the connector shafts 16 such that the second driven die plate 44 can be prevented from being excessively lowered when the second upper and lower dies 55 and 56 are opened (i.e., such that the second upper and lower dies 54 and 56 can be prevented from being excessively opened). Thus, lowering motion of the second driven die plate 44 (the second lower die 56) can be limited by the stopper members 16b. Further, each of the stopper members 16b is adjustably attached to the connector shaft 16, so as to change a farthest lower position of the second driven die plate 44 (the second lower die 56).

The second upper die 54 is constructed to mate with the second lower die 56, thereby press forming the material M2. As shown in, for example, FIG. 1, similar to the first upper die 50, the second upper die 54 is detachably connected to the lower surface of the first driven die plate 42 via a right and left pair of second upper die attaching structures respectively having support blocks 80. Further, the second upper die attaching structures respectively have the same structures as the first upper die attaching structures. Therefore, a detailed description of the second upper die attaching structures may be omitted.

The second lower die 56 is constructed to mate with the second upper die 54, thereby press forming the material M2. Similar to the first lower die 52, the second lower die 56 is detachably connected to the upper surface of the second driven die plate 44 via a right and left pair of second lower die attaching structures respectively having support blocks 80′. Further, the second lower die attaching structures (the support blocks 80′) respectively have the same structures as the first lower die attaching structures. Therefore, a detailed description of the second lower die attaching structures may be omitted.

Next, the third die unit 34 will be described. The third die unit 34 is constructed of the second driven die plate 44, a fixed die plate 46 paired with the second driven die plate 44, a third upper die 58, and a third lower die 60 paired with the third upper die 58.

Further, the second driven die plate 44 is a construction element common to the second and third die units 32 and 34 and is already described in detail. Therefore, a detailed description of the second driven die plate 44 may be omitted.

The fixed die plate 46 may function as a base plate to which the third lower die 60 is attached. The fixed die plate 46 is secured to the upper surface of the lower frame 10 by fastening devices (not shown).

The third upper die 58 is constructed to mate with the third lower die 60, thereby press forming the material M3. As shown in, for example, FIG. 1, similar to the first and second upper dies 50 and 54, the third upper die 58 is detachably connected to the lower surface of the second driven die plate 44 via a right and left pair of third upper die attaching structures respectively having support blocks 80. Further, the third upper die attaching structures respectively have the same structures as the first and second upper die attaching structures. Therefore, a detailed description of the third upper die attaching structures may be omitted.

The third lower die 60 is constructed to mate with the second upper die 54, thereby press forming the material M3. Similar to the first and second lower dies 52 and 56, the third lower die 60 is detachably connected to an upper surface of the fixed die plate 46 via a right and left pair of third lower die attaching structures respectively having support blocks 80′. Further, the third lower die attaching structures (the support blocks 80′) respectively have the same structures as the first and second lower die attaching structures. Therefore, a detailed description of the third lower die attaching structures may be omitted.

The frame portion 2 and the press portion 3 are respectively constructed as described above.

A press forming operation of the triple press molding machine 1 constructed of the frame portion 2 and the press portion 3 will now be described with reference to FIGS. 1 and 7.

First, as shown in FIG. 1, upon reverse actuation of the press cylinder 20, the cylinder rod 22 is contracted, so that the triple press molding machine 1 is opened (i.e., the first upper and lower dies 50 and 52, the second upper and lower dies 54 and 56 and the third upper and lower dies 58 and 60 are respectively opened). Thereafter, the materials M1, M2 and M3 are disposed on the first to third lower dies 52, 54 and 60.

Subsequently, the press cylinder 20 is actuated, so that the cylinder rod 22 is projected downwardly. As a result, the drive die plate 40 can be lowed toward the lower frame 10 while the guide holes 40a are respectively guided by the guide shafts 14. Simultaneously, the first driven die plate 42 and the second driven die plate 44 can be lowed toward the lower frame 10 in synchrony with the drive die plate 40 while the guide holes 42a and 44a are respectively guided by the guide shafts 14. At this time, the first driven die plate 42 can be lowered while contacting the stopper members 16a until the second upper die 54 contacts the second lower die 56. Therefore, a distance between the first driven die plate 42 and the drive die plate 40 can be maintained in a predetermined distance (a distance shown in FIG. 1) until the second upper die 54 contacts the second lower die 56. Similarly, the second driven die plate 44 can be lowered while contacting the stopper members 16b until the third upper die 58 contacts the third lower die 60. Therefore, a distance between the second driven die plate 44 and the first driven die plate 42 can be maintained in a predetermined distance (a distance shown in FIG. 1) until the third upper die 58 contacts the third lower die 60.

When the drive die plate 40, the first driven die plate 42 and the second driven die plate 44 are further lowed, the third upper die 58 contacts the third lower die 60 while the material M3 is clamped therebetween. Subsequently, the second upper die 54 contacts the second lower die 56 while the material M2 is clamped therebetween. Finally, the first upper die 50 contacts the first lower die 52 while the material M1 is clamped therebetween.

When the cylinder rod 22 is further projected downwardly, the drive die plate 40, the first driven die plate 42 and the second driven die plate 44 can be further lowed while the first driven die plate 42 and the second driven die plate 44 are respectively spaced from the stopper members 16a and 16b (i.e., while the distance between the first driven die plate 42 and the drive die plate 40 and the distance between the second driven die plate 44 and the first driven die plate 42 are respectively reduced). As a result, as shown in FIG. 7, the first upper and lower dies 50 and 52, the second upper and lower dies 54 and 56 and the third upper and lower dies 58 and 60 are respectively closed, so that the materials M1, M2 and M3 can be press formed. Thus, molded articles W1, W2 and W3 can be produced.

Upon completion of press forming of the materials M1, M2 and M3, the press cylinder 20 is reverse actuated again, so that the cylinder rod 22 is contracted. As a result, the drive die plate 40 is lifted toward the upper frame 12, so that the first upper and lower dies 50 and 52 can be opened.

When the drive die plate 40 is further lifted, the stopper members 16a can contact the first driven die plate 42. As a result, the first driven die plate 42 is lifted with the drive die plate 40 via the stopper members 16a, so that the second upper and lower dies 54 and 56 can be opened.

When the drive die plate 40 is further lifted, the stopper members 16b can contact the second driven die plate 44. As a result, the second driven die plate 44 is lifted with the drive die plate 40 and the first driven die plate 42 via the stopper members 16b, so that the third upper and lower dies 58 and 60 can be opened.

After the first upper and lower dies 50 and 52, the second upper and lower dies 54 and 56 and the third upper and lower dies 58 and 60 are respectively opened, the press cylinder 20 is deactuated. Thereafter, the formed molded articles W1, W2 and W3 are removed from the first to third lower dies 52, 54 and 60. Thus, the press forming operation of the triple press molding machine 1 is completed.

According to the triple press molding machine 1 thus constructed, each of the guide holes 40a, 42a and 44a formed in the drive die plate 40, the first driven die plate 42 and the second driven die plate 44 has the diameter sufficiently greater than the diameter D of each of the guide shafts 14. Thus, even when the guide shafts 14 are flexed due to the large load applied to the lower frame 10 via the upper frame 12, the guide holes 40a, 42a and 44a can effectively absorb the produced flexural deformation of the guide shafts 14. Therefore, the guide holes 40a, 42a and 44a can be reliably guided by the guide shafts 14, so that the drive die plate 40, the first driven die plate 42 and the second driven die plate 44 can smoothly move up and down.

Further, according to the triple press molding machine 1 thus constructed, the bushes 70 are respectively attached to the drive die plate 40, the first driven die plate 42 and the second driven die plate 44 via the connector bolts B. The diameter of each of the through bores 74 of the bushes 70 is smaller than the diameter of each of the guide holes 40a, 42a and 44a. Therefore, the bushes 70 can increase the guiding accuracy of the guide shafts 14 to the guide holes 40a, 42a and 44a. Thus, the guide holes 40a, 42a and 44a can be reliably guided by the guide shafts 14, so that the drive die plate 40, the first driven die plate 42 and the second driven die plate 44 can further smoothly move up and down. As a result, the drive die plate 40, the first driven die plate 42 and the second driven die plate 44 can be effectively prevented from being inclined or rattled.

Further, according to the triple press molding machine 1 thus constructed, the first to third upper dies 50, 54 and 58 are respectively connected to the drive die plate 40, the first driven die plate 42 and the second driven die plate 44 via the first to third upper die attaching structures (the support blocks 80) while the clearances S1 and S2 are formed therebetween. Similarly, the first lower dies 52, 56 and 60 are respectively connected to the first driven die plate 42, the second driven die plate 44 and the fixed die plate 46 via the first to third lower die attaching structures (the support blocks 80′) while the clearances S1 and S2 are formed therebetween. Therefore, if the large force is applied to the dies 50, 52, 54, 56, 58 and 60 during closing or opening operations thereof, the dies 50, 52, 54, 56, 58 and 60 can move vertically and laterally relative to the drive die plate 40, the first driven die plate 42 and the second driven die plate 44.

Therefore, even when the guide holes 40a, 42a and 44a cannot sufficiently absorb the flexural deformation of the guide shafts 14, the dies 50, 52, 54, 56, 58 and 60 can effectively absorb the flexural deformation of the guide shafts 14. As a result, even when the flexural deformation of the guide shafts 14 is extremely large, the drive die plate 40, the first driven die plate 42 and the second driven die plate 44 can smoothly move up and down.

Various changes and modifications may be made to the multiple press molding machine. For example, in an embodiment, the vertical triple press molding machine 1 is exemplified as the multiple press molding machine. However, a horizontal triple press molding machine can be used as the multiple press molding machine. Further, double, quadruple or quintuple press molding machines can be used as the multiple press molding machine.

In an embodiment, the first to third upper dies 50, 54 and 58 are lowered toward the first to third lower dies 52, 56 and 60, thereby closing the first upper and lower dies 50 and 52, the second upper and lower dies 54 and 56 and the third upper and lower dies 58 and 60. However, the first to third lower dies 52, 56 and 60 can be moved upwardly toward the first to third upper dies 50, 54 and 58, thereby closing the first upper and lower dies 50 and 52, the second upper and lower dies 54 and 56 and the third upper and lower dies 58 and 60. Naturally, in such a case, the press cylinder 20 is connected to a lower surface of the lower frame 10 while the cylinder rod 22 thereof vertically penetrates the lower frame 10.

In an embodiment, the bushes 70 are attached to the upper and lower surfaces of each of the drive die plate 40, the first driven die plate 42 and the second driven die plate 44. However, the bushes 70 can be attached to either one of the upper and lower surfaces of each of the drive die plate 40, the first driven die plate 42 and the second driven die plate 44.

In an embodiment, the first to third upper dies 50, 54 and 58 are respectively detachably connected to the drive die plate 40, the first driven die plate 42 and the second driven die plate 44 via the first to third upper die attaching structures having the support blocks 80. Further, the first to third lower dies 52, 56 and 60 are respectively detachably connected to the first driven die plate 42, the second driven die plate 44 and the fixed die plate 46 via the first to third lower die attaching structures having the support blocks 80′. However, the first to third upper dies 50, 54 and 58 can respectively be fixedly connected to the drive die plate 40, the first driven die plate 42 and the second driven die plate 44 via fixture bolts. Further, the first to third lower dies 52, 56 and 60 can respectively be fixedly connected to the first driven die plate 42, the second driven die plate 44 and the fixed die plate 46 via fixture bolts. Instead, the first to third upper dies 50, 54 and 58 can respectively be integrally formed with the drive die plate 40, the first driven die plate 42 and the second driven die plate 44. Further, the first to third lower dies 52, 56 and 60 can respectively be integrally formed with the first driven die plate 42, the second driven die plate 44 and the fixed die plate 46 via fixture bolts. The vertical triple press molding machine 1 thus modified is suitable for drawing, ironing or other such processing.

Embodiments of the inventions have been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detailed description may not be necessary to practice the inventions in the broadest sense, and are instead taught merely to particularly describe detailed representative examples of the inventions. Moreover, the various features taught in this specification may be combined in ways that are not specifically enumerated in order to obtain additional useful embodiments of the inventions.

1. A multiple press molding machine, comprising:
a plurality of guide shafts; and
a plurality of die units each of which includes a pair of dies, a plurality of guide holes and a plurality of bushes each having a through bore,
wherein each of the bushes is positioned so as to surround at least one open peripheries of each of the guide holes,
wherein the guide shafts are respectively inserted into the guide holes of the die units and the through bores of the bushes, so that die closing and opening motion can be guided, and
wherein the through bore of each of the bushes has an inner diameter smaller than a diameter of each of the guide holes.

2. The multiple press molding machine as in claim 1, wherein each of the die units includes movable die plates, wherein the guide holes are formed in the movable die plates so as to penetrate the movable die plates in a thickness direction thereof, and wherein each pair of dies are detachably connected to the movable die plates, so as to move in a die closing and opening direction and a direction perpendicular thereto.
